(19) United States
(12) Patent Application Publication
(10) Pub. No.: US 2006/0250348 A1
(43) Pub. Date: Nov. 9, 2006

(54) Electrophoretic display device and driving method

(75) Inventors: Guofu Zhou, Eindhoven (NL); Mark Thomas Johnson, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/557,345

(22) PCT Filed: May 13, 2004
(86) PCT No.: PCT/IB04/50692

§ 371 Date: Nov. 21, 2005

(30) Foreign Application Priority Data
May 22, 2003 (EP) 03101478.0

(51) Int. Cl. G09G 3/34

(52) U.S. Cl. 345/107

(57) ABSTRACT

A display device (1) comprises two or more groups of display elements having electrophoretic particles (8,9), a pixel electrode (5) and a counter electrode (6). Drive signals (50, (V,t)_{drive}, (V,t)ᵣₑₛₑₜ) are supplied to the electrodes to bring the display elements in a predetermined optical state. The drive signals are preceded by preset signals (53, (V,t)ₚᵣₑₛₑₜ) to release the electrophoretic particles but too low in intensity to enable the particles to change the optical state significantly. The preset signals supplied to the groups show differences in phase. This reduces flicker. The preset and drive signals are, in operation, so supplied that the phase of the preset pulse preceding the drive pulse is, in respect of the drive pulse, substantially the same for all groups. The combination of a drive and preceding preset pulse is then for the groups substantially the same, reducing grey level variations.

The invention relates to a display device comprising electrophoretic particles, a display element comprising a pixel electrode and a counter electrode between which a portion of the electrophoretic particles are present, and control means for supplying a drive signal to the electrodes to bring the display element in a predetermined optical state.

Display devices of this type are used in, for example, monitors, laptop computers, personal digital assistants (PDA's), mobile telephones and electronic books, electronic newspapers and electronic magazines.

A display device of the type mentioned in the opening paragraph is known from the international patent application WO 99/53373. This patent application discloses a electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a pixel electrode. A row driver selects a row of display elements and the column driver supply a data signal to the selected row of display elements via the column electrodes and the TFT transistors. The data signals corresponds to graphic data to be displayed.

Furthermore, an electronic ink is provided between the pixel electrode and a common electrode provided on the transparent substrate. The electronic ink comprises multiple microcapsules, of about 10 to 50 microns. Each microcapsule comprises positively charged white particles and negatively charge black particles suspended in a fluid. When a positive field is applied to the pixel electrode, the white particles move to the side of the micro capsule directed to the transparent substrate and the display element becomes visible to a viewer. Simultaneously, the black particles move to the pixel electrode at the opposite side of the microcapsule where they are hidden to the viewer. By applying a negative field to the pixel electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to counter electrode at the top of the microcapsules. For example, the energy of the positive or negative electric field, defines as the product of field strength and time of application, controls the amount of particles moving to the top of the microcapsules.

The known display devices exhibit a so called dwell time. The dwell time is defined as the interval between a previous image update and a new image update.

A disadvantage of the present display is that it exhibits an underdrive effect which leads to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later.

It is an object of the invention to provide a display device of the type mentioned in the opening paragraph which can be applied to improve the reproduction of grey scales.

To achieve this object, a first aspect of the invention provides a display device as described in the opening paragraph characterized in that
a. the control means are further arranged for supplying a preset signal preceding the drive signal comprising a preset pulse preceding a drive pulse, the preset pulse having an energy sufficient to release the electrophoretic particles at a first position near one of the two electrodes corresponding to a first optical state, but too low to enable the particles to reach a second position near the other electrode corresponding to a second optical state and
b. the display elements are divided in two or more groups, and
c. the control means are arranged for generating and supplying to the groups preset signals showing differences in phase between the groups and in that
d. the control means are arranged for generating and supplying to each of the groups preset pulses and drive pulses such that the phase of the preset pulse preceding the drive pulse is, in respect of the drive pulse, substantially the same for all groups.

The invention is based on a number of recognitions the first of which is that the optical response depends on the history of the display element. The inventors have observed (feature a) that when a preset signal is supplied before a drive signal to the pixel electrode, which preset signal comprising a pulse with an energy sufficient to release the electrophoretic particle from a static state at one of the two electrodes, but too low too reach the other one of the electrodes, the underdrive effect is reduced. Because of the reduced underdrive effect the optical response to an identical data signal will be substantially equal, regardless of the history of the display device and in particular its dwell time. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the preset pulses increases the momentum of the electrophoretic particles and thus shortens the switching time. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

A further advantage is that the application of the preset pulses substantially eliminates a prior history of the electronic ink, whereas in contrast conventional electronic ink display devices require massive signal processing circuits for the generation of data pulses of a new frame, storage of several previous frames and a large look-up table.

The preset pulses themselves do not have a great effect on the grey scales displayed. However, there is a small jitter or flicker effect as the inventors have recognized. By arranging the elements in groups (feature b) and supplying them with preset pulses which have different phases (feature c) (when two groups are used, which is the preferred and simplest arrangement, having opposite phases, i.e. being 180° out of phase), the flicker effect occurs in each of the groups, but since the flicker effect does not occur simultaneously in all groups, the overall effect is much smaller. Preferably the phase differences are evenly distributed, i.e. when there are n groups, the phase differences are 360°/n. This smoothing effect reduces the jitter or flicker effect. For example, when in a single frame addressing period the preset pulses are applied with a positive polarity to all even rows and a negative polarity to all odd rows adjacent rows of the display device will appear alternately brighter and darker and in the subsequent frame addressing period the positive and negative polarities of the preset pulses are inverted, the perceptual appearance will then hardly be effected, as the eye integrates these short brightness fluctuations both across the display (spatial integration) and over subsequent frames (temporal averaging). This principle is similar to the line inversion principle in methods for driving liquid crystal displays with reduced flicker. However, when a preset pulse precedes the drive pulse, the part of the preset pulse, adjacent to the drive pulse, to some extent, cooperates with the drive pulse, it becomes in effect a first part of the drive signal. In itself this does not pose a problem. However, when the elements are divided into groups, having different preset pulses, the phase difference in the preset pulses may lead to effective differences in length of the drive pulses applied to the different groups. This in turn leads to differences in grey scales between the groups and to stripes being visible in the image as the inventors have recognized. In the device in accordance with the invention the preset pulses and drive pulses are so arranged that for all groups the phase of the preset pulse preceding the drive pulse is, in respect of the drive pulse, substantially the same (feature d). So for each group the combination of drive pulse and preceding preset pulse is substantially the same. The combined grey scale effect of the preset pulse preceding the drive pulse and the drive pulse is then substantially the same, reducing variations in grey scale.

A preset pulse can have a duration of one order of magnitude less than the time interval between two subsequent image update. An image update is the instance where the image information of the display device is renewed or refreshed.

In embodiments of the invention the control means are arranged so that the drive signal comprises a drive pulse to bring the display elements to one of its extreme optical states, i.e. the black or the white optical state.

The drive pulse is then a so-called reset pulse, i.e. a pulse to bring the display element to one of the extreme optical state, the white or black state.

In embodiments of the invention the control means are arranged so that the drive signal comprises a pulse to bring the display elements to a grey scale, i.e. a position in between the extreme optical states.

In a preferred embodiment of the invention the control means are arranged so that the drive signals supplied to a first and a second group of display elements have a mutual time difference substantially equal to the period of a single preset pulse.

It is remarked that for simplicity the extreme optical states are hereinbelow and hereinabove called the “white” and the “black” optical state, and optical states in between the two extreme states are called “grey scales”. However, the negatively and positively charged particles may, within the scope of the invention, have color different from black and white (e.g. black and red, or black and green, or black and blue, or any other color combination).

Further advantageous embodiments of the invention are specified in the dependent claims.

In an embodiment the power dissipation of the display device can be minimised by applying just a single preset pulse.

In an embodiment a preset signal consisting of an even number of preset pulses of opposite polarity can be generated for minimising the DC component and the visibility of the preset pulses of the display device. Two preset pulses, one with positive polarity and one with negative polarity will minimize the power dissipation of the display device within this mode of operation.

In an embodiment the electrodes are arranged to form a passive matrix display.

In an embodiment the preset signals are generated in the second driving means and applied to the pixel electrodes simultaneously by selecting, for example, all even followed by all odd rows at a time by the first driving means. This embodiment requires no additional electronics on the substrates.

In an embodiment the preset signals are applied directly via the counter electrode to the pixel electrode. An advantage of this arrangement is that the power consumption is lower because the capacitance involved in this case is lower than in a case were the row or column electrodes are addressed.

In an embodiment the counter electrode is divided in several portions, in order to reduce the visibility of the preset pulses.

In an embodiment the pixel electrode is coupled via a first additional capacitive element. The voltage pulses on the pixel electrode can now be defined as the ratio of a pixel capacitance and the first additional capacitive element. The pixel capacitance is the intrinsic capacitance of the material between the pixel electrode and the transparent substrate. Particularly, in combination with an encapsulated electrophoretic material as supplied by E-Ink Corporation, this embodiment can be advantageous because in case the first additional capacitive element is selected to have a large value compared to the pixel capacitance, the preset signal will substantially be transmitted to the pixel electrode, which reduces the power consumption.

Furthermore, the pixel capacitance will not vary significantly with the different applied grey levels. Thus, the preset pulse on the pixel electrode will be substantially equal for all display elements irrespective of the applied grey levels.

In an embodiment the pixel element is coupled to the control means via a further switching element. The further switching elements enables dividing of the display elements in two or more groups in an easy manner.

These and other aspects of the invention are apparent from and will be elucidated with reference to the embodiments described hereinafter.

In the drawings:

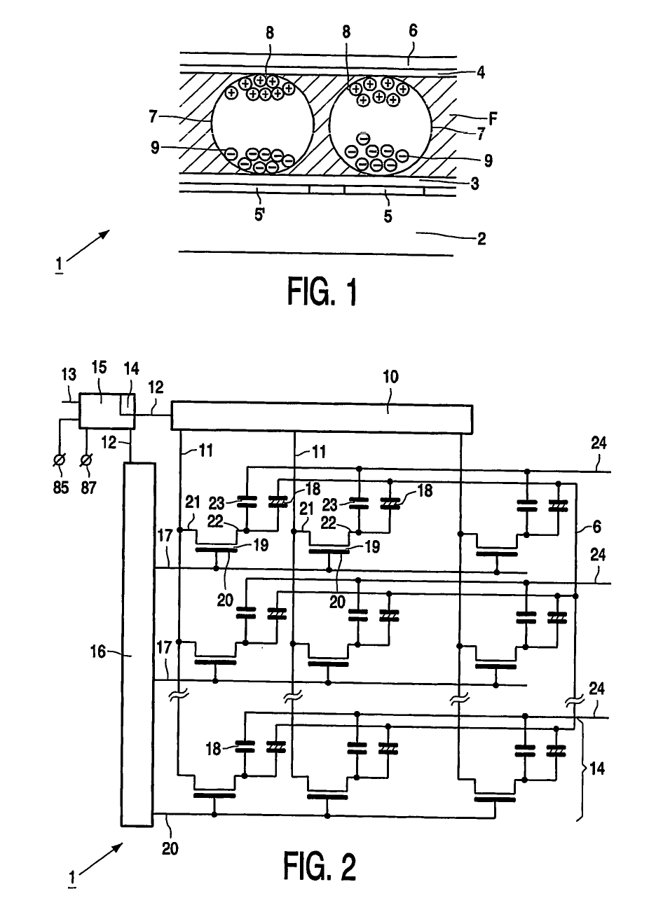

FIG. 1 shows diagrammatically a cross-section of a portion of a display device,

FIG. 2 shows diagrammatically an equivalent circuit diagram of a portion of a display device,

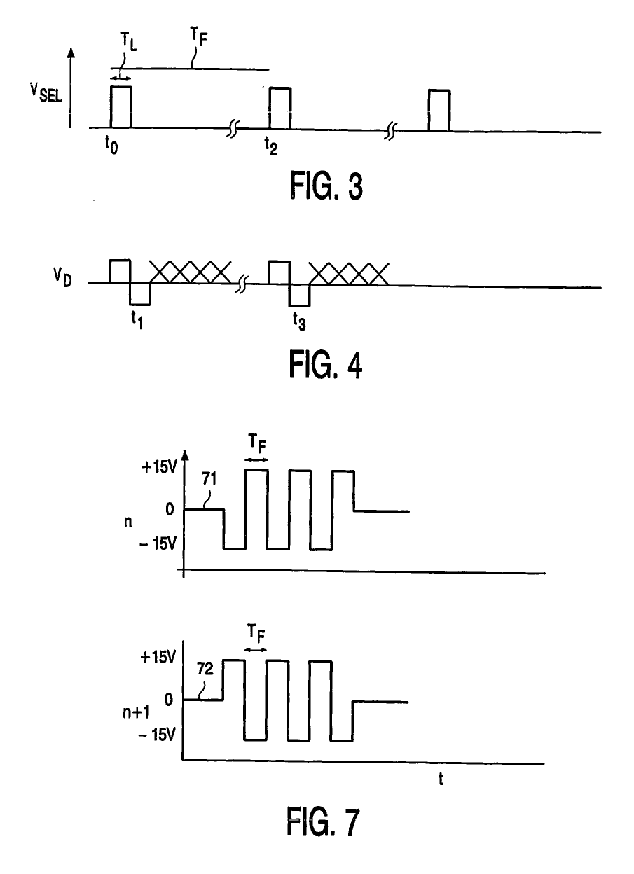

FIGS. 3 and 4 show drive signals and internal signal of the display device,

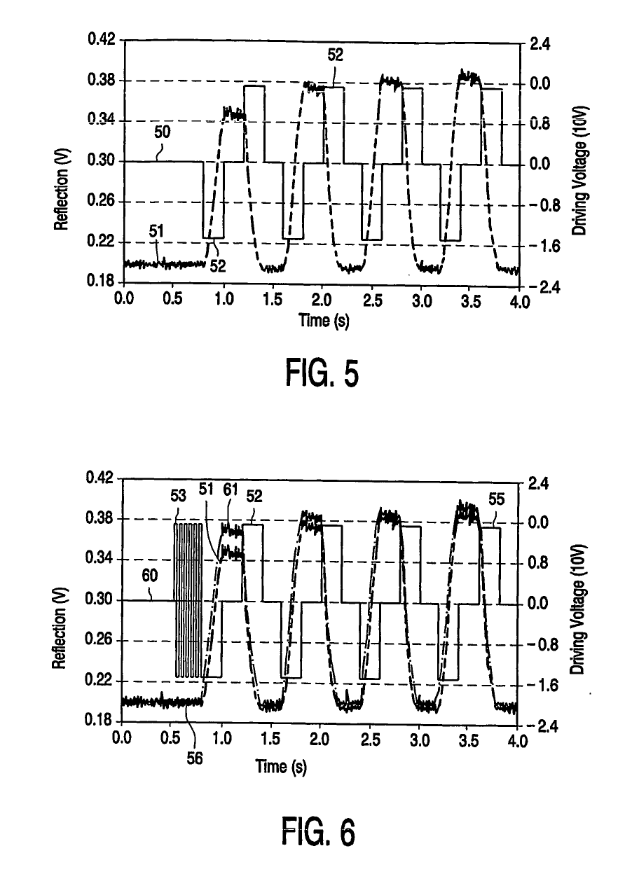

FIG. 5 shows an optical response of a data signal,

FIG. 6 shows an optical response of a preset signal and a data signal

FIG. 7 shows preset signals for pixel electrode for two adjacent rows or columns consisting of 6 pulses of opposite polarities,

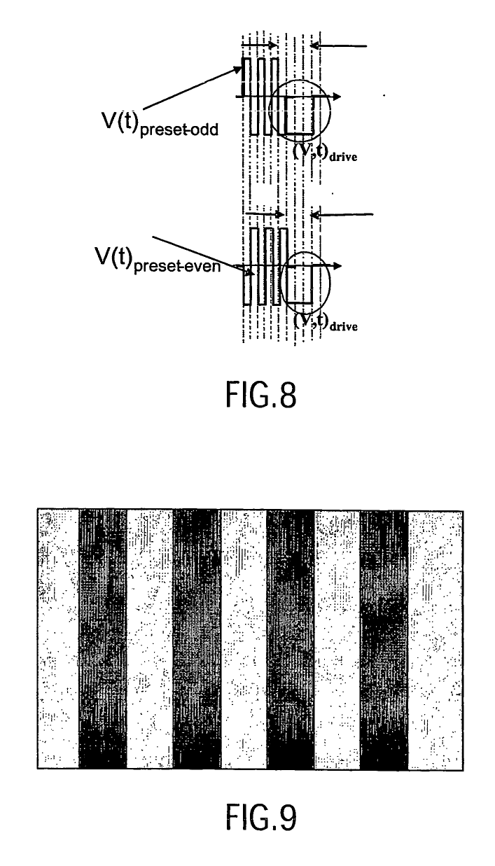

FIG. 8 shows preset signals and drive pulses for different groups.

FIG. 9 shows the result of differences in the combination of preset and drive pulses on grey level and image reproduction.

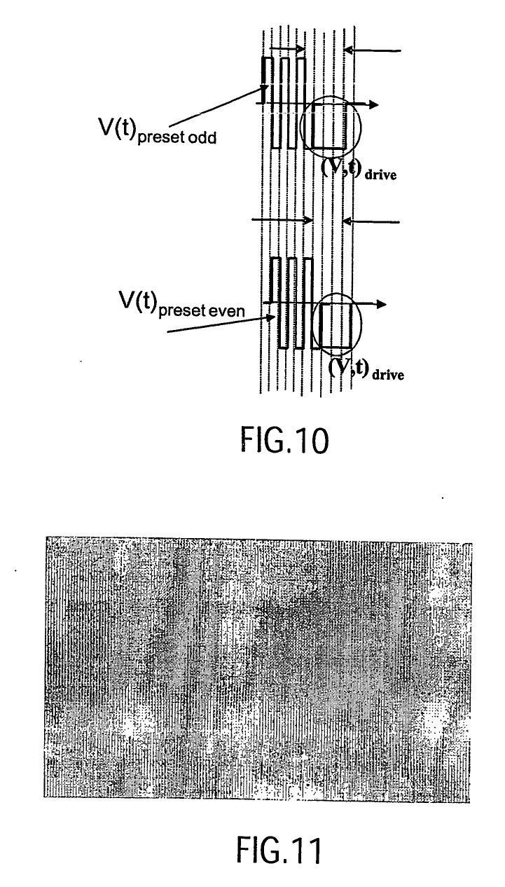

FIG. 10 shows a scheme in accordance with the invention.

FIG. 11 shows the resulting grey level variation.

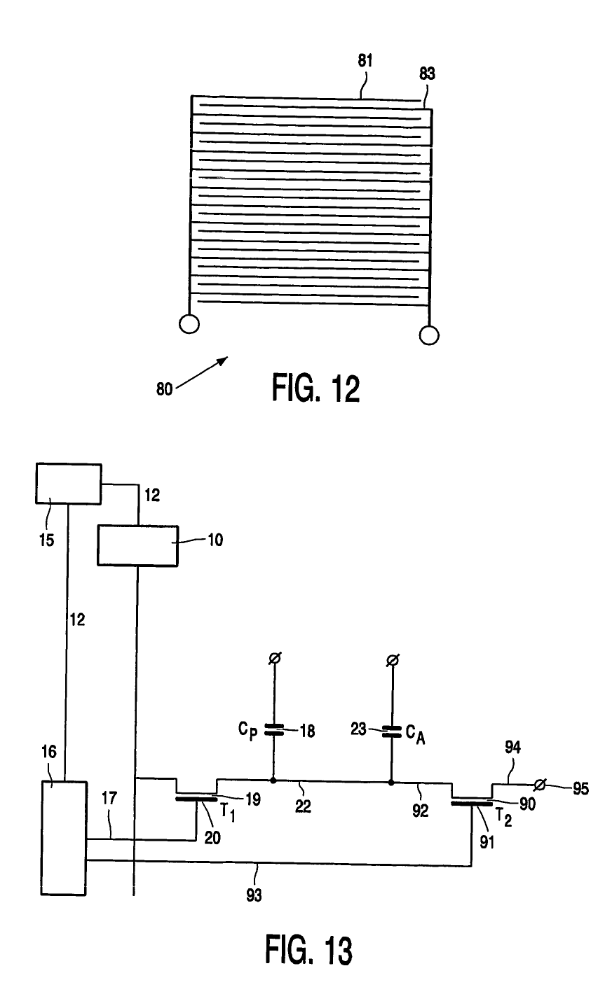

FIG. 12 shows an example of a counter electrode comprising interdigitized comb structures and

FIG. 13 shows an equivalent circuit of a display element with two TFTs.

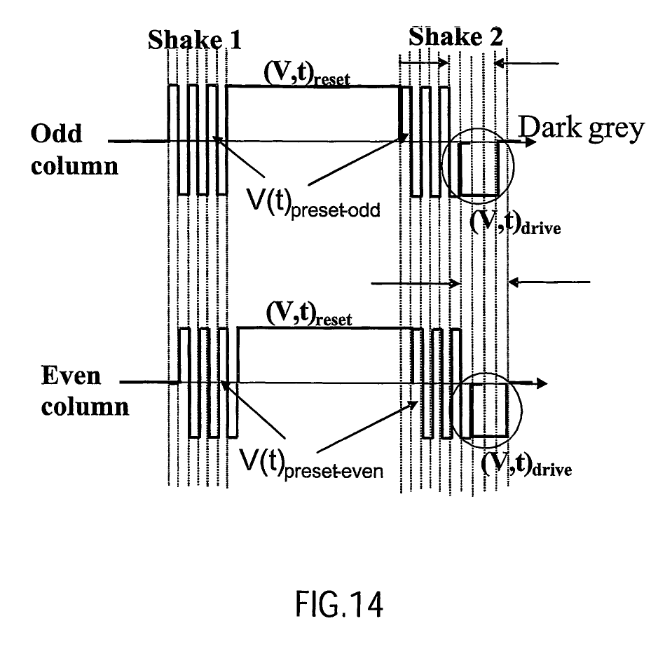

FIG. 14 illustrates a scheme for preset and driving pulses in a more complex embodiment of the invention.

The Figures are schematic and not drawn to scale, and, in general, like reference numerals refer to like parts.

FIG. 1 diagrammatically shows a cross section of a portion of an electrophoretic display device 1, for example of the size of a few display elements, comprising a base substrate 2, an electrophoretic film with an electronic ink which is present between two transparent substrates 3,4 for example polyethylene, one of the substrates 3 is provided with transparent picture electrodes 5 and the other substrate 4 with a transparent counter electrode 6. The electronic ink comprises multiple micro capsules 7, of about 10 to 50 microns. Each micro capsule 7 comprises positively charged white particles 8 and negative charged black particles 9 suspended in a fluid F. When a positive field is applied to the pixel electrode 5, the white particles 8 move to the side of the micro capsule 7 directed to the counter electrode 6 and the display element become visible to a viewer. Simultaneously, the black particles 9 move to the opposite side of the microcapsule 7 where they are hidden to the viewer. By applying a negative field to the pixel electrodes 5, the black particles 9 move to the side of the micro capsule 7 directed to the counter electrode 6 and the display element become dark to a viewer (not shown). When the electric field is removed the particles 8, 9 remains in the acquired state and the display exhibits a bi-stable character and consumes substantially no power.

FIG. 2 shows diagrammatically an equivalent circuit of a picture display device 1 comprising an electrophoretic film laminated on a base substrate 2 provided with active switching elements, a row driver 16 and a column driver 10. Preferably, a counter electrode 6 is provided on the film comprising the encapsulated electrophoretic ink, but could be alternatively provided on a base substrate in the case of operation using in-plane electric fields. The display device 1 is driven by active switching elements, in this example thin film transistors 19. It comprises a matrix of display elements at the area of crossing of row or selection electrodes 17 and column or data electrodes 11. The row driver 16 consecutively selects the row electrodes 17, while a column driver 10 provides a data signal to the column electrode 11. Preferably, a processor 15 firstly processes incoming data 13 into the data signals. Mutual synchronisation between the column driver 10 and the row driver 16 takes lace via drive lines 12. Select signals from the row driver 16 select the pixel electrodes 22 via the thin film transistors 19 whose gate electrodes 20 are electrically connected to the row electrodes 17 and the source electrodes 21 are electrically connected to the column electrodes 11. A data signal present at the column electrode 11 is transferred to the pixel electrode 22 of the display element coupled to the drain electrode via the TFT. In the embodiment, the display device of FIG. 1 also comprises an additional capacitor 23 at the location at each display element 18. In this embodiment, the additional capacitor 23 is connected to one or more storage capacitor lines 24. Instead of TFT other switching elements can be applied such as diodes, MIM's, etc.

FIGS. 3 and 4 show drive signals of a conventional display device. At the instance t₀, a row electrode 17 is energized by means of a selection signal Vsel (FIG. 1.), while simultaneously data signals Vd are supplied to the column electrodes 11. After a line selection time T_{L} has elapsed, a subsequent row electrode 17 is selected at the instant t₁, etc. After some time, for example, a field time or frame time, usually 16.7 msec or 20 msec, said row electrode 17 is energized again at instant t₂ by means of a selection signal Vsel, while simultaneously the data signals Vd are presented to the column electrode 11, in case of an unchanged picture. After a selection time T_{L} has elapsed, the next row electrode is selected at the instant t₃. This is repeated from instant t₄. Because the bistable character of the display device, the electrophoretic particles remains in their selected state and the repetition of data signals can be halted after several frame times when the desired grey level is obtained. Usually, the image update time is several frames.

FIG. 5 shows a first signal 51 representing an optical response of a display element of the display device of FIG. 2, on a data signal 50 comprises pulses of alternating polarity after a dwell period of several seconds. In FIG. 5 the optical response 51 is indicated by ---- and the data signal by ______. Each pulse 52 of the data signal 50 has a duration of 200 ms and a voltage of alternating plus and minus 15 V. FIG. 5 shows that the optical response 51 after the first negative pulse 52 is not a desired grey level, which is obtained only after the third or fourth negative pulse.

In order to improve the accuracy of the desired grey level with the data signal the processor 15 generates a single preset pulse or a series of preset pulses before the data pulses of a next refresh field, where the pulse time is typically 5 to 10 times less than the interval between an image update and a next subsequent image update. In case the interval between two image updates is 200 ms. The duration of a preset pulse is typically 20 ms.

FIG. 6 shows the optical response of a data signal 60 of the display device of FIG. 2 as a response of a series of 12 preset pulses of 20 ms and data pulses of 200 ms having a voltage of alternating polarity of plus and minus 15 V. In FIG. 6 the optical response 51 is indicated by ----, the improved optical response 61 by -.-.-.-.- and the data signal by ______. The series of preset pulses consists of 12 pulses of alternating polarity. The voltage of each pulse is plus or minus 15 V. FIG. 6 shows an significant increase of the grey scale accuracy, the optical response 61 is substantially at an equal level as the optical response after the fourth data pulse 55. The application of preset pulses, which are pulses having an energy sufficient to release the electrophoretic particles at a first position near one of the two electrodes corresponding to a first optical state, but too low to enable the particles to reach a second position near the other electrode corresponding to a second optical state thus increases the quality of the image. However, some flicker may become visible introduced by the preset pulses, see optical response 56. In order to reduce the visibility of this flicker, the processor 15 and the row driver 16 can be arranged such that the row electrodes 17 associated with display elements are interconnected in two groups, and the processor 15 and the column driver 10 are arranged for executing an inversion scheme by generating a first preset signal having a first phase to the first group of display elements and a second reset signal having a second phase to the second group of display element, whereby the second phase is opposite to the first phase. Alternatively, multiple groups can be defined, whereto preset pulses are supplied with different phases. For example, the row electrodes 17 can be interconnected in two groups one of the even rows and one group of the odd row whereby the processor generates a first preset signal consisting of six preset pulses of alternating polarity of plus and minus 15 V starting with a negative pulse to the display elements of the even rows and a second preset signal consists of six preset pulses of alternating polarity of plus and minus 15 V starting with a positive pulse to display elements of the odd rows.

FIG. 7 shows two graphs indicative for an inversion scheme. A first graph 71 relates to a first preset signal consisting of 6 preset pulses of 20 ms supplied to a display element of an even row n and a second graph 72 related to a second preset signal consisting of 6 preset pulses of 20 ms supplied to a display element of an odd row n+1, whereby the phase of the second preset signal is opposite the phase of the first preset signal. The voltage of the pulse is alternating between plus and minus 15 V.

Instead of the series of preset pulses applied to two or more different groups of rows, the display elements can be divided in two groups of columns, for example, one group of even columns and one group of odd columns whereby the processor 15 executes an inversion scheme by generating a first preset signal consisting of six preset pulses of alternating polarity of plus and minus 15 V starting with a negative pulse to the display elements of the even columns and a second preset signal consists of six preset pulses of alternating polarity of plus and minus 15 V starting with a positive pulse to the display elements of the odd columns. Here, all rows can be selected simultaneously. In further embodiments, inversion schemes as just discussed can be simultaneously supplied to both rows and columns to generate a so called dot-inversion scheme, which still further reduces optical flicker. In general the flicker can be reduced by providing two or more groups and introducing phase differences in the preset pulses between the groups. In FIG. 7 two groups are used and thus the phase difference is 180 degrees. However, within the larger concept of the invention, although the use of two groups (or four when for rows and columns the scheme in accordance with the invention is used) is preferred, three, four or more groups may be used. In general if n groups are used the phase difference between groups that have adjacent element is preferably 360 degrees/n.

Thus, dividing, preferably by interconnecting, the display elements in two or more groups (rows or columns or any other arrangement of groups), and arranging the control means for generating and supplying to the groups preset signals showing differences in phase between the groups reduces the visibility of flicker.

The preset signals and pulses could also be called “shake” or “shake-up” signals or pulses. Their effect is to “shake-up” the display element, before application of a drive pulse.

Although the flicker is reduced, the inventors have realized that a different problem may arise. FIG. 8 shows example waveforms, in which a series of odd and even preset pulses (V(t)_{preset-odd} and V(t)ₚᵣₑₛₑₜ₋ₑᵥₑₙ) and driving pulses ((V,t)_{drive}) is used, using column inversion. In this example, the preset pulses start with positive sign at odd columns and negative sign at even columns. The effective driving time is actually determined by a combination of the preset-pulse preceding the drive pulse and the drive pulse and the length of the effective drive pulse at odd columns is one frame (one pulse length of the preset pulse) longer than that at even columns, resulting in a difference in optical state between the columns. The effective driving pulse length is in the figure indicated by arrows. The resulting image reproduction is shown in FIG. 9, showing that the even and odd columns have a difference in grey scale. These stripes are often visible to viewers, reducing the quality of image.

The solution for this problem is schematically shown in FIG. 10. By making the phase of the preset pulse preceding the drive pulse to be, in respect of the drive pulse, substantially the same for all groups, the effective length of the drive pulse is substantially the same for all groups. This will reduce the stripe effect. The disadvantage is that timing of the image update for the different groups shows a small variations. However, this effect is much less visible than the stripe effect. FIG. 11 illustrates the effect of the solution on the image. The preset pulses are the same as in FIG. 8, but whereas the drive pulses in FIG. 8 were simultaneously and completely in phase, in FIG. 10 the driving pulses for the even columns are shifted by one preset pulse length, so that when a combination of the drive pulse and the immediately preceding preset pulse (the part of FIGS. 8 and 10 within the circles) is considered this combination is substantially the same for both groups in FIG. 10, whereas in FIG. 8 a difference in length and thus in effect, and thus in a variation in grey scale occurs. As a consequence the image of FIG. 9 shows a striped appearance, due to the variations in grey scale between the groups, whereas the image of FIG. 11 does not show (or at least to a much smaller degree) such gery scale variations. By making the phase of the preset pulses in respect of the driving pulses substantially the same for all groups differences in grey scale between the groups are reduced.

Division of the elements in groups may e.g. be accomplished by a counter electrode 80 shaped as two interdigitized comb structures 81,83 as shown in FIG. 12 in order to reduce optical flicker. This kind of electrode is well known to the skilled person. The two counter electrodes 81,83 are coupled to two outputs 85,87 of the processor 15. Furthermore, the processor 15 is arranged for generating an inversion scheme by supplying a first preset signal consisting of six preset pulses of 20 ms, preferably delayed by the duration of one preset pulse and alternating polarity of plus and minus 15 V starting with a negative pulse to the first comb structure 81 and a second preset signal consisting of six preset pulses of 20 ms of alternating polarity of plus and minus 15 V starting with a positive pulse to the to the second comb structure 83, whilst holding the pixel electrode 23 at 0 V. After the preset pulses are supplied to both sets of columns the two comb structures 81,83 can, if desired be connected to each other before new data is supplied to display device.

In a further embodiment, the preset pulses can be applied by the processor 15 via the additional storage capacitors 23 by charge sharing between the additional storage capacitor 23 and the pixel capacitance 18. In this embodiment, the storage capacitors on a row of display element are connected to each other via a storage capacitor line and the row driver 16 is arranged to interconnect these storage capacitor lines to each other in two groups enabling inversion of the preset pulses over two groups, a first group related to ever rows of display elements and a second group related to odd rows of picture elements. In order to improve grey scale reproduction before new data is supplied to the display element, the row driver executes an inversion scheme by generating a first preset signal consisting of 6 preset pulses of alternating polarity to the first group and a second preset signal consisting of 6 preset pulses, delayed by the duration of one pulse and of alternating polarity to the second group whereby the phase of the second signal is opposite the phase of the first signal. After the preset pulses are supplied to both sets of the display elements, the storage capacitors can, if desired be grounded before the new data is supplied to the display elements.

In a next further embodiment, the preset pulses can be applied directly to the pixel electrode 22 by the processor 15 via an additional thin film transistor 90 coupled via its source 94 to a dedicated preset pulse line 95 as shown in FIG. 13. The drain 92 is coupled to the pixel electrode 22. The gate 91 via a separate preset pulse addressing line 93 to the row driver 16. The addressing TFT 19 must be non-conducting by, for example, setting the row electrode 17 to 0 V.

As explained above, when the preset signal is applied to all display elements simultaneously flicker may occur. Therefore in this example, preset signal inversion is applied by division of the additional thin film transistors 90 in two groups, one group connected with display elements of even rows and one group connected with display elements of odd rows. Both groups of TFT's 90 are separately addressable and connected to the preset pulse lines 95. The processor 15 executes an inversion scheme by generating a first preset signal consisting of for example, 6 preset pulses of 20 ms and a voltage 15 V with alternating polarity to the first group of TFT's 90 via the preset pulse line 95 and a second preset signal consisting of 6 preset pulses of 20 ms and a voltage of 15 V, delayed by the duration of one preset pulse and with alternating polarity to the second groups of TFT's 90 whereby the phase of the second signal is opposite the phase of the first signal. Alternatively, a single set of TFT's addressable in the same time can be attached to two separate preset pulse lines with inverted pre set pulses.

After the preset signal are supplied to the TFT's 90 of both sets of pixels, the TFT's are deactivated before new data is supplied via the column drivers 10.

Furthermore, further power reductions are possible in the described embodiments by applying any of the well-known charge recycling techniques to the (inverted) preset pulse sequences to reduce the power used to charge and discharge pixel electrodes during the preset pulse cycles.

The drive signal or drive pulse may be a drive signal to drive the display element to one of its extreme optical state, i.e. to make the display element “White” or “black”. The drive pulse may also be a pulse to apply a grey scale to a display element, i.e. to bring a display element, starting from an optical state, often an extreme optical state, to an optical state in between the extreme optical states.

Both of such types of drive signals may be preceded by preset pulses.

FIG. 14 illustrates this. To the odd and even columns preset signals (Shake 1, V(t)ₚᵣₑₛₑₜ₋ₑᵥₑₙ and V(t)_{preset-odd} are provided followed by a reset signal (V,t)ᵣₑₛₜₑ. The preset signals applied to the odd and even columns are 180° out of phase. The reset signal (V,t)ᵣₑₛₑₜ drives the display elements into one of the extreme optical states, in this example the black state. The reset signals form a type of drive signals since they drive the display element into an optical state. The reset signal is followed by preset signals (shake 2), which are in their turn followed by a grey scale drive signal (V,t)_{drive} to drive the display element to a dark grey level. The grey scale drive signal (V,t)_{drive} illustrates a second type of drive signals, which drive the display element from an extreme optical state (be it black or white) to a grey scale. When use is made of reset signals, driving the display elements to an extreme optical state, the following grey scale drive signals are generally of an sign opposite to the sign of the preceding reset signal. The shape and form of the grey scale drive signal (V,t)_{drive} as well as the reset signal (V,t)ᵣₑₛₑₜ to odd and even columns are substantially identical (assuming of course that for the drive signal the display elements are to be driven to the same grey level) but there is a time delayed substantially identical to the period of a single preset pulse between the drive signals to the groups. As a consequence when the phase of the preset signals is seen in respect of the drive signals, they are the same for both groups, and the combination of the drive signals (V,t)ᵣₑₛₑₜ and/or (V,t)_{drive} and the preceding preset signal are the same. Thus the resulting grey level is substantially the same for both groups. In this example the drive signals of the even columns are delayed by a time period T_{F}.

In short the invention can be described by:

A display device (1) comprises two or more groups of display elements having electrophoretic particles (8,9), a pixel electrode (5) and a counter electrode (6). Drive signals (50, (V,t)_{drive}, (V,t)ᵣₑₛₑₜ) are supplied to the electrodes to bring the display elements in a predetermined optical state. The drive signals are preceded by preset signals (53, (V,t)ₚᵣₑₛₑₜ) to release the electrophoretic particles but too low in intensity to enable the particles to change the optical state significantly. The preset signals supplied to the groups show differences in phase. This reduces flicker. The preset and drive signals are, in operation, so supplied that the phase of the preset pulse preceding the drive pulse is, in respect of the drive pulse, substantially the same for all groups. The combination of a drive and preceding preset pulse is then for the groups substantially the same, reducing grey level variations.

It will be obvious that many variations are possible within the scope of the invention without departing from the scope of the appended claims.

1. A display device (1) comprising electrophoretic particles (8,9), a display element comprising a pixel electrode (5) and a counter electrode (6) between which a portion of the electrophoretic particles (8,9) are present, and control means (10, 15, 16) for supplying a drive signal (50, (V,t)_{drive}, (V,t)ᵣₑₛₑₜ) to the electrodes to bring the display element in a predetermined optical state, characterized in that
a. the control means are further arranged for supplying a preset signal (53, (V,t)ₚᵣₑₛₑₜ) preceding the drive signal comprising a preset pulse preceding a drive pulse, the preset signal representing an energy sufficient to release the electrophoretic particles at a first position near one of the two electrodes corresponding to a first optical state, but too low to enable the particles to reach a second position near the other electrode corresponding to a second optical state and
b. the display elements are divided in two or more groups, and
c. the control means are arranged for generating and supplying to the groups preset signals showing differences in phase between the groups and in that
d. the control means are arranged for generating and supplying to each of the groups preset pulses and drive pulses such that the phase of the preset pulse preceding the drive pulse is, in respect of the drive pulse, substantially the same for all groups.

2. A display device as claimed in claim 1, characterized in that the control means are arranged so that the drive signal comprises a drive pulse ((V,t)ᵣₑₛₑₜ) to bring the display elements to one of its extreme optical states.

3. A display device as claimed in claim 1, characterized in that the control means are arranged so that the drive signal comprises a grey scale driving pulse ((V,t)_{drive}) to bring the display elements to a position in between extreme optical states.

4. A display device as claimed in claim 1, characterized in that the polarity of the preset pulse preceding the drive pulse is opposite to the polarity of the drive pulse for each of the groups.

5. A display device as claimed in claim 1, characterized in that the display elements are interconnected in two groups and control means are arranged for generating and supplying a first preset signal having a first phase to the first group and a second preset signal to the second group having a second phase opposite to the first phase wherein the drive signal of one group is identical in form to that of the second group, but is delayed by a time period identical to the period (T_{F}) of a single preset pulse

6. A display device as claimed in claim 1 wherein the duration of the preset pulse is one order of magnitude less than a time interval between two subsequent image updates.

7. A display device as claimed in claim 1 wherein the control means are further arranged for generating an even number of preset pulses.

8. A display device as claimed in claim 1 wherein one of the electrodes comprises a data electrode and the other electrode comprises a selection electrode and the control means further comprising first drive means for applying a selection signal to the selection electrodes and second drive means for applying a data signal to the data electrode.

9. A display device as claimed in claim 1 wherein the pixel electrode of the display element is being coupled to a selection electrode or a data electrode via a switching element, and the control means further comprising first drive means for applying a selection signal to the selection electrodes and second drive means for applying a data signal to the data electrode.

10. A display device as claimed in claim 8, wherein selection electrodes associated with display elements are interconnected in two groups, and the control means being arranged for generating a first preset signal having a first phase to the first group and a second reset signal to the second group having a second phase opposite to the first phase.

11. A display device as claimed in claim 8, wherein the second drive means are arranged for generating the preset signal.

12. A display device as claimed in claim 8, wherein the pixel electrode is coupled to the control means for generation of the preset signal via the counter electrode.

13. A display device as claimed in claim 12, wherein the counter electrode is divided into two portions, wherein each portion is associated with a set of display elements connected via a selection electrode.

14. A display device as claimed in claim 9, wherein the pixel electrode is coupled via a first additional capacitive element to the control means for receiving the preset signal.

15. A display device as claimed in claim 9, wherein the pixel electrode is being coupled to the control means via a further switching element.

16. A display device as claimed in claim 1, wherein the electrophoretic material is an encapsulated electrophoretic material.
